(19) United States
(12) Patent Application Publication
(10) Pub. No.: US 2014/0289185 A1
(43) Pub. Date: Sep. 25, 2014

(54) Apparatus and Method for Policy Based Rebalancing in a Distributed Document-Oriented Database

(71) Applicant: MARKLOGIC CORPORATION, San Carlos, CA (US)

(72) Inventors: Christopher Lindblad, Berkeley, CA (US); Wayne Feick, San Ramon, CA (US); Haitao Wu, Fremont, CA (US)

(73) Assignee: MARKLOGIC CORPORATION, San Carlos, CA (US)

(21) Appl. No.: 13/848,008

(22) Filed: Mar. 20, 2013

(51) Int. Cl. G06F 17/30

(52) U.S. Cl. CPC G06F 17/30011
USPC 707/608

(57) ABSTRACT

A method includes storing a partition of a distributed document-oriented database in a computer. It is determined whether an assignment policy is unsatisfied, where the assignment policy specifies locations for documents within the distributed document-oriented database. A request for a transfer transaction to move a document from the computer is initiated when the assignment policy is unsatisfied. There is a wait for an indication of a transfer transaction commit or a transfer transaction abort. The transfer transaction is completed in the event of a transfer transaction commit, such that the document is moved from the computer. The transfer transaction is aborted in the event of a transfer transaction abort, such that the document remains at the computer.

### FIELD OF THE INVENTION

This invention relates generally to distributed databases in networked environments. More particularly, this invention relates to policy based rebalancing in a distributed document-oriented database.

### BACKGROUND OF THE INVENTION

A distributed database is an information store that is controlled by multiple computational resources. For example, a distributed database may be stored in multiple computers located in the same physical location or may be dispersed over a network of interconnected computers. Unlike parallel systems, in which processors are tightly coupled and constitute a single database system, a distributed database has loosely coupled sites that share no physical components and therefore gives rise to the term shared nothing database.

One type of data source that may exist in a distributed database is a document-oriented database, which stores semi-structured data. In contrast to well-known relational databases with “relations” or “tables”, a document-oriented database is designed around the abstract notion of a document. While relational databases utilize Structured Query Language (SQL) to extract information, document-oriented databases do not rely upon SQL and therefore are sometimes referred to as NoSQL databases.

Document-oriented database implementations differ, but they all assume that documents encapsulate and encode data in some standard formats or encodings. Encodings in use include eXtensible Markup Language (XML), Yet Another Markup Language (YAML), Javascript Object Notation (JSON), Binary JSON (BSON), Portable Document Format (PDF) and Microsoft® Office® documents. Documents inside a document-oriented database are similar to records or rows in relational databases, but they are less rigid. That is, they are not required to adhere to a standard schema.

In a document-oriented database, documents are addressed via a unique key that represents the document or a portion of the document. The key may be a simple string. In some cases, the string is a Uniform Resource Identifier (URI) or path. Typically, the database retains an index on the key for fast document retrieval.

In a distributed document-oriented database, the number of documents among multiple nodes can get unbalanced overtime, especially when new nodes are added to the system. Without a good rebalancing mechanism, the system is hard to scale up.

Many NoSQL databases provide rebalancing functionalities. For example, Cassandra® picks the node with the highest “load” and places a new node on the ring to take over around half of the heaviest-loaded node's work. MongoDB® uses a mechanism called “sharding”. It partitions a collection and stores the different portions on different machines. When a database's collections become too large for existing storage, you need only add a new machine. Sharding automatically distributes collection data to the new server.

Prior art techniques that perform rebalancing commonly have data consistency problems. Therefore, it would be desirable to provide improved rebalancing techniques in distributed document-oriented databases.

### SUMMARY OF THE INVENTION

A method includes storing a partition of a distributed document-oriented database in a computer. It is determined whether an assignment policy is unsatisfied, where the assignment policy specifies locations for documents within the distributed document-oriented database. A request for a transfer transaction to move a document from the computer is initiated when the assignment policy is unsatisfied. There is a wait for an indication of a transfer transaction commit or a transfer transaction abort. The transfer transaction is completed in the event of a transfer transaction commit, such that the document is moved from the computer. The transfer transaction is aborted in the event of a transfer transaction abort, such that the document remains at the computer.

A non-transitory computer readable storage medium includes instructions executed by a processor to store a partition of a distributed document-oriented database in a computer. A transfer transaction to move a document from the computer is requested. The state of the transfer transaction is logged on the computer until the transfer transaction is committed. The document is removed from the computer after the transfer transaction is committed, such that the document resides on another resource associated with the distributed document-oriented database.

### BRIEF DESCRIPTION OF THE FIGURES

The invention is more fully appreciated in connection with the following detailed description taken in conjunction with the accompanying drawings, in which:

FIG. 1 illustrates a computer that may be utilized in accordance with an embodiment of the invention.

FIG. 2 illustrates components used to construct a document-oriented database.

FIG. 3 illustrates processing operations to construct a document-oriented database.

FIG. 4 illustrates a markup language document that may be processed in accordance with an embodiment of the invention.

FIG. 5 illustrates a top-down tree characterizing the markup language document of FIG. 4.

FIG. 6 illustrates an exemplary index that may be formed to characterize the document of FIG. 4.

FIG. 7 illustrates a system configured in accordance with an embodiment of the invention.

FIG. 8 illustrates processing operations associated with an embodiment of the invention.

FIG. 9 illustrates a code sample and corresponding journal entries for a single partition utilized in accordance with an embodiment of the invention.

FIGS. 10-11 illustrate a code sample and corresponding journal entries for multiple partitions utilized in accordance with an embodiment of the invention.

Like reference numerals refer to corresponding parts throughout the several views of the drawings.

### DETAILED DESCRIPTION OF THE INVENTION

A semi-structured document, such as an XML document has two parts: 1) a markup document and 2) a document schema. The markup document and the schema are made up of storage units called “elements”, which can be nested to form a hierarchical structure. The following is an example of an XML markup document:

```
<citation publication_date=01/02/2012>
  <title>MarkLogic Query Language</title>
  <author>
    <last>Smith</last>
    <first>John</first>
  </author>
  <abstract>
```

The MarkLogic Query Language is a new book from MarkLogic Publishers that gives application programmers a thorough introduction to the MarkLogic query language.

</abstract>
</citation>

This document contains data for one “citation” element. The “citation” element has within it a “title” element, an “author” element and an “abstract” element. In turn, the “author” element has within it a “last” element (last name of the author) and a “first” element (first name of the author). Thus, an XML document comprises text organized in freely-structured outline form with tags indicating the beginning and end of each outline element. In XML, a tag is delimited with angle brackets followed by the tag's name, with the opening and closing tags distinguished by having the closing tag beginning with a forward slash after the initial angle bracket.

Elements can contain either parsed or unparsed data. Only parsed data is shown for the example document above. Unparsed data is made up of arbitrary character sequences. Parsed data is made up of characters, some of which form character data and some of which form markup. The markup encodes a description of the document's storage layout and logical structure. XML elements can have associated attributes in the form of name-value pairs, such as the publication date attribute of the “citation” element. The name-value pairs appear within the angle brackets of an XML tag, following the tag name.

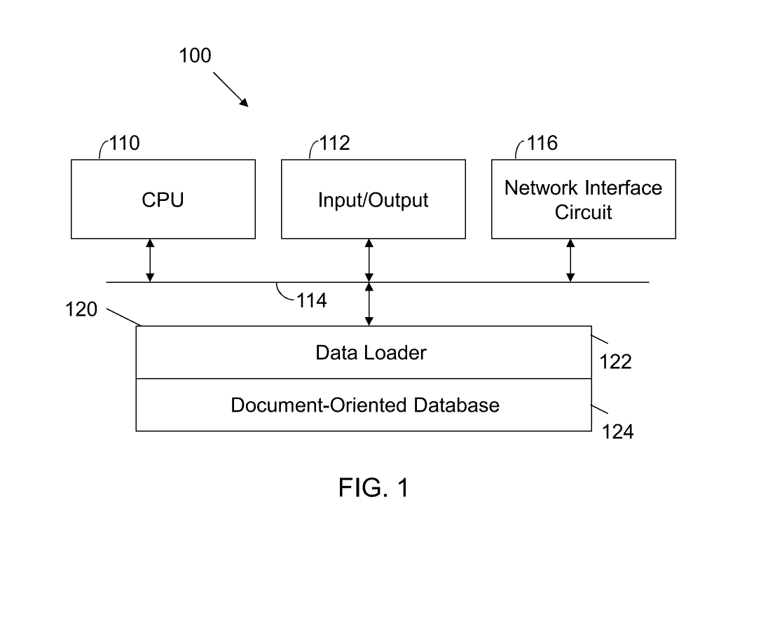

FIG. 1 illustrates a computer 100 configured in accordance with an embodiment of the invention. The computer 100 includes standard components, such as a central processing unit 110 and input/output devices 114 connected via a bus 114. The input/output devices may include a keyboard, mouse, touch screen, display and the like. A network interface circuit 116 is also connected to the bus 114. Thus, the computer 100 may operate in a networked environment.

A memory 120 is also connected to the bus 114. The memory 120 includes data and executable instructions to implement on or more operations associated with the invention. A data loader 122 includes executable instructions to process documents and form document segments and selective pre-computed indices, as described herein. These document segments and indices are then stored in a document-oriented database 124.

The modules in memory 120 are exemplary. These modules may be combined or be reduced into additional modules. The modules may be implemented on any number of machines in a networked environment. It is the operations of the invention that are significant, not the particular architecture by which the operations are implemented.

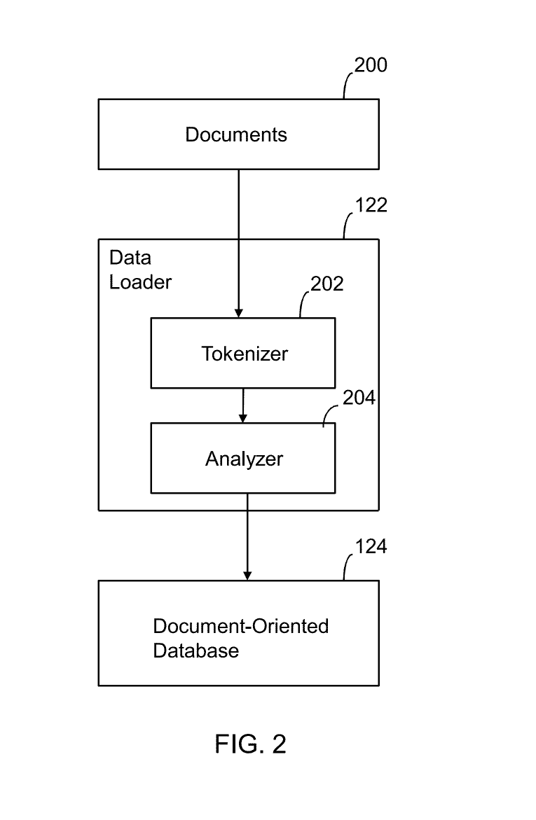

FIG. 2 illustrates interactions between components used to implement an embodiment of the invention. Documents 200 are delivered to the data loader 122. The data loader 122 may include a tokenizer 202, which includes executable instructions to produce tokens or segments for components in each document. An analyzer 204 includes executable instructions to form document segments with the tokens. The document segments characterize the structure of a document. For example, in the case of a top-down tree the characterization is from a root node through a set of fanned out nodes. The document segments may be an entire tree or portions (paths) within the tree. The analyzer also develops a set of pre-computed indices. The term pre-computed indices is used to distinguish from indices formed in response to a query. The resultant document segments and pre-computed indices are separately searchable entities, which are loaded into a document-oriented database 124. The document segments support queries. The pre-computed indices also support queries.

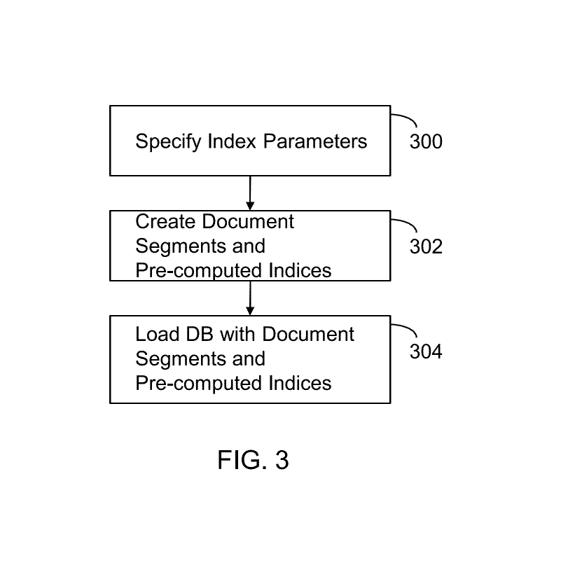

FIG. 3 illustrates processing operations associated with the components of FIG. 2. Initially, index parameters are specified. The pre-computed indices have specified path parameters. The path parameters may include element paths and attribute paths. An element is a logical document component that either begins with a start-tag and ends with a matching end-tag or consists only of an empty-element tag. The characters between the start- and end-tags, if any, are the element's content and may contain markup, including other elements, which are called child elements. An example of an element is <Greeting>Hello, world.</Greeting>.

An attribute is a markup construct comprising a name/value pair that exists within a start-tag or empty-element tag. In the following example the element img has two attributes, src and alt: <img src=“madonna.jpg” alt=‘Foligno Madonna, by Raphael’/>. Another example is <step number=“3”>Connect A to B.</step> where the name of the attribute is “number” and the value is “3”.

The next processing operation of FIG. 3 is to create document segments and pre-computed indices 302. Finally, a database is loaded with the document segments and pre-computed indices 304.

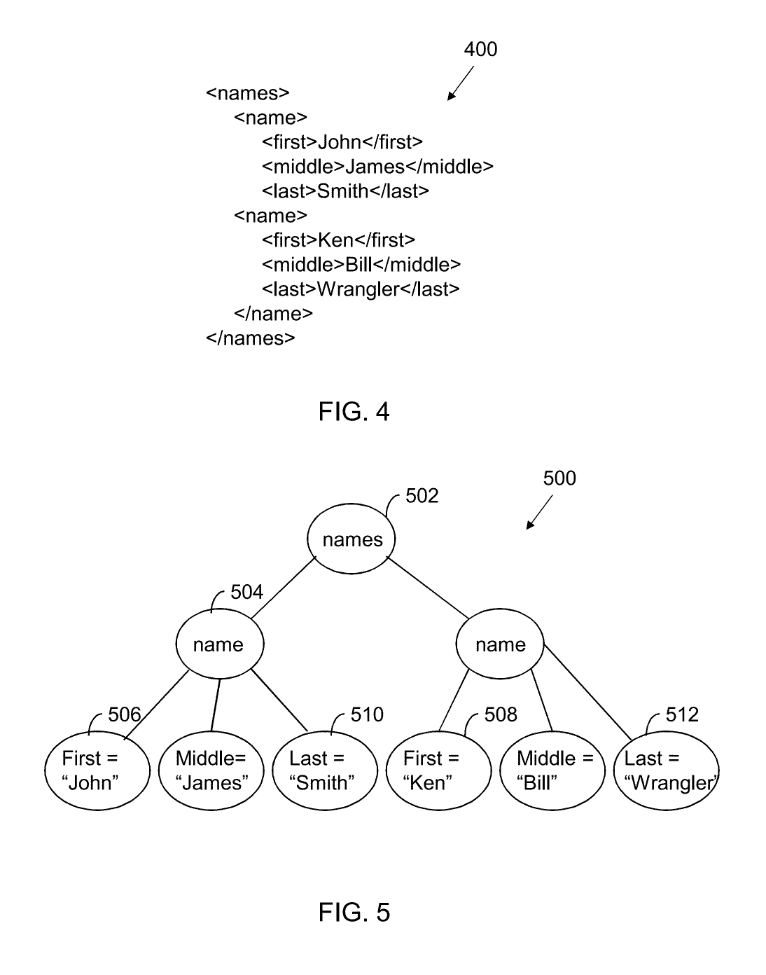

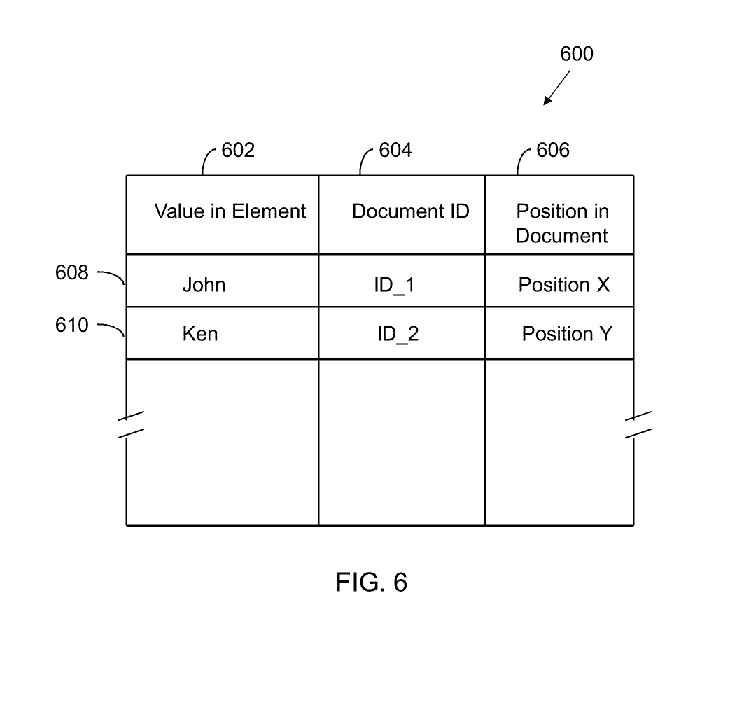

FIG. 4 illustrates a document 400 that may be processed in accordance with the operations of FIG. 3. The document 400 expresses a names structure that supports the definition of various names, including first, middle and last names. In this example, the document segments are in the form of a tree structure characterizing this document, as shown in FIG. 5. This tree structure naturally expresses parent, child, ancestor, descendent and sibling relationships. In this example, the following relationships exist: “first” is a sibling of “last”, “first” is a child of “name”, “middle is a descendent of “names” and “names” is an ancestor of “middle”.

Various path expressions (also referred to as fragments) may be used to query the structure of FIG. 5. For example, a simple path may be defined as /names/name/first. A path with a predicate may be defined as /names/name[middle=“James”]/first. A path with a wildcard may be expressed as /*/name/first, where * represents a wildcard. A path with a descendent may be express as //first.

The indices used in accordance with embodiments of the invention provide summaries of data stored in the database. The indices are used to quickly locate information requested in a query. Typically, indices store keys (e.g., a summary of some part of data) and the location of the corresponding data. When a user queries a database for information, the system initially performs index look-ups based on keys and then accesses the data using locations specified in the index. If there is no suitable index to perform look-ups, then the database system scans the entire data set to find a match.

User queries typically have two types of patterns including point searches and range searches. In a point search a user is looking for a particular value, for example, give me last names of people with first-name=“John”. In a range search, a user is searching for a range of values, for example, give me last names of people with first-name>“John” AND first-name<“Pamela”.

The structure 500 of FIG. 5 is a tree representation of the XML document 400 of FIG. 4. A natural way of traversing trees is top-down, where one starts the traversal at the root node 502 and then visits the name node 504 followed by the first node 506. A path expression is a branch of a tree. An arbitrary branch of a tree, also referred to herein as a document segment, may be used to form a pre-computed index.

Document trees may be traversed at various times, such as when the document gets inserted into the database and after an index look-up has identified the document for filtering. Document segments (paths) are traversed at various times: (1) when a document is inserted into a database, (2) during index resolution to identify matching indices, (3) during index look-up to identify all the values matching the user specified path range and (4) during filtering. The pre-computed indices of the invention may be utilized during these different path traversal operations.

Various pre-computed indices may be used. The indices may be named based on the type of sub-structure used to create them. Embodiments of the invention utilize pre-computed element range indices, element-attribute range indices, path range indices, field range indices and geospatial range indices, such as geospatial element indices, geospatial element-attribute range indices, geospatial element-pair indices, geospatial element-attribute-pair indices and geospatial indices.

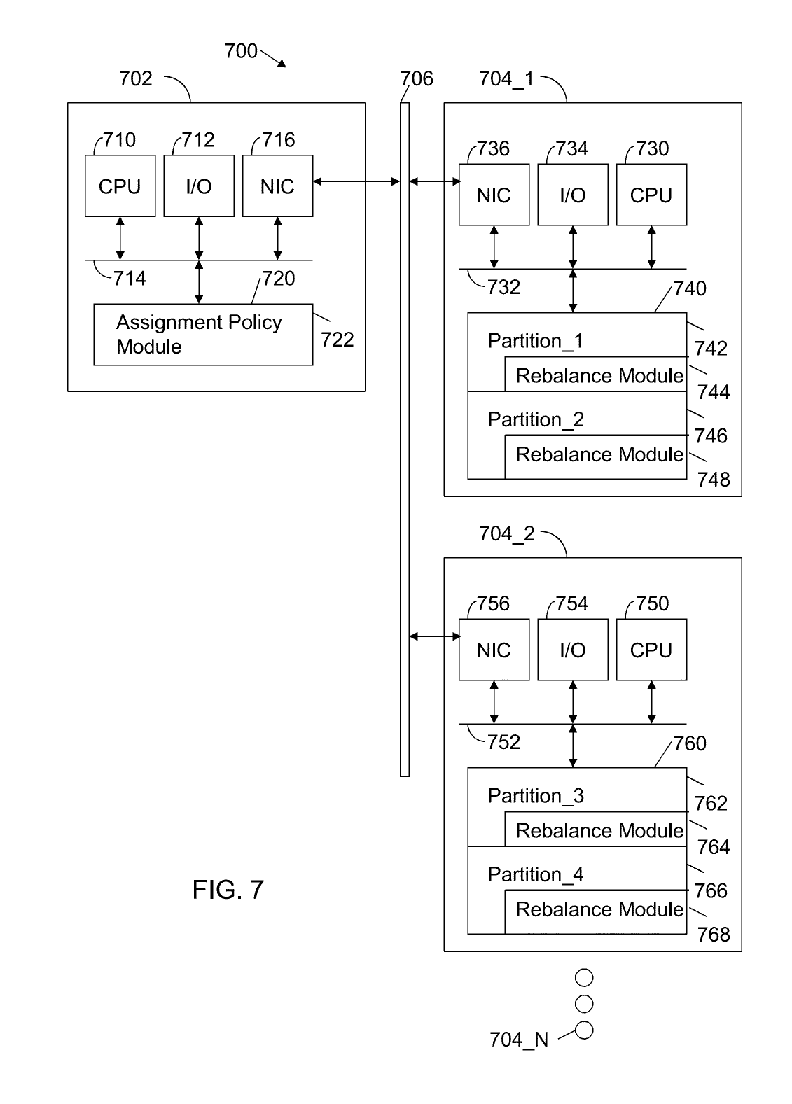

FIG. 6 illustrates an element range index 600 that may be used in accordance with an embodiment of the invention. The element range index 600 stores individual elements from the tree structured document 500. The element range index 600 includes value column 602, a document identifier column 604 and position information in the document 606. Entry “John” 608 corresponds to element 506 in FIG. 5, while entry “Ken” 610 corresponds to element 508 in FIG. 5.

The foregoing information characterizes a document-oriented database, which stands in contrast to a relational database. The document-oriented database may be partitioned across a number of nodes to form a distributed document-oriented database. Thus, a document-oriented database is a collection of database partitions. A database partition is a collection of document segments and corresponding indices. A document segment is a document or segment of a document, as described above.

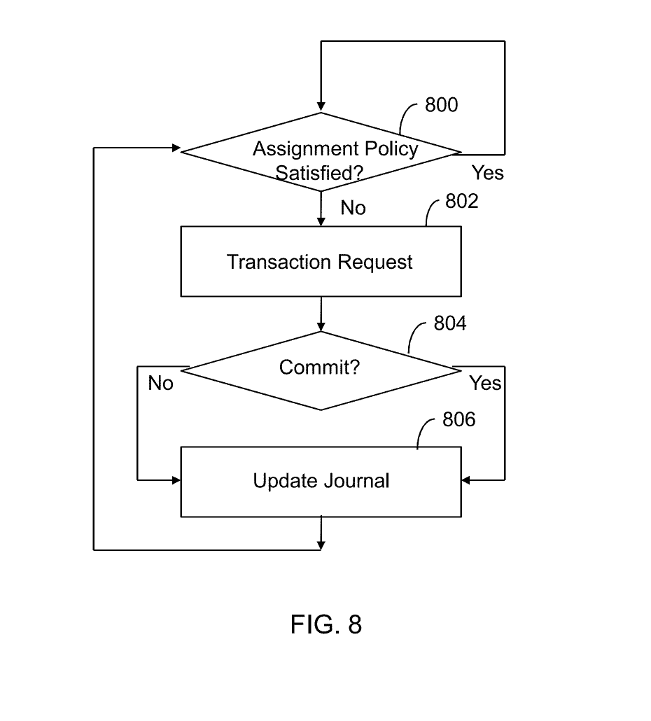

FIG. 7 illustrates a system 700 configured in accordance with an embodiment of the invention. The system 700 implements a distributed database. The system includes a master device 702 and a set of worker nodes 704_1 through 704_N connected via a network 706, which may be any wired or wireless network.

The master device 702 includes standard components, such as a central processing unit 710 connected to input/output devices 712 via a bus 714. A network interface circuit 716 is also connected to the bus 714. A memory 720 is also connected to the bus 714. The memory 720 stores an assignment policy module 722. The assignment policy module 722 includes executable instructions to implement an assignment policy which dictates how to rebalance the document-oriented database as the database receives additional documents, has worker nodes added and/or has worker nodes deleted. The assignment policy module 722 may be distributed across nodes 704, as discussed below.

Each worker node 704 includes standard components, such as a central processing unit 730 and input/output devices 734 connected via a bus 732. A network interface circuit 736 is also connected to the bus 732. A memory 740 is also connected to the bus 732. The memory 740 stores executable instructions to implement operations of the invention. In one embodiment, the memory 740 stores a first database partition 742, which has an associated rebalance module 744. The rebalance module 744 includes executable instructions to perform rebalance operations with respect to content within the partition 742. The rebalance module 744 is a processing thread that communicates with the assignment policy module 722 to implement local rebalancing operations, as specified by the assignment policy module 722. The rebalance module 744 may include executable instructions corresponding to all of or a subset of the executable instructions associated with the assignment policy module 722. The rebalance module 744 is invoked during new document inserts and during ongoing rebalance operations.

The memory 740 also stores a second partition 746, which also has an associated rebalance module 748. Any number of partitions may be resident in memory 740.

FIG. 7 also illustrates a worker node 704_2, which includes standard components, such as a central processing unit 750 and input/output devices 754 connected via a bus 752. A network interface circuit 756 is also connected to the bus 752. A memory 760 is also connected to the bus 752. The memory 760 stores a third database partition 762, which has an associated rebalance module 764. The memory 760 also stores a fourth partition 766, which also has an associated rebalance module 768. Any number of partitions may be resident in memory 760. The additional processing nodes through 704_N may each have a similar configuration.

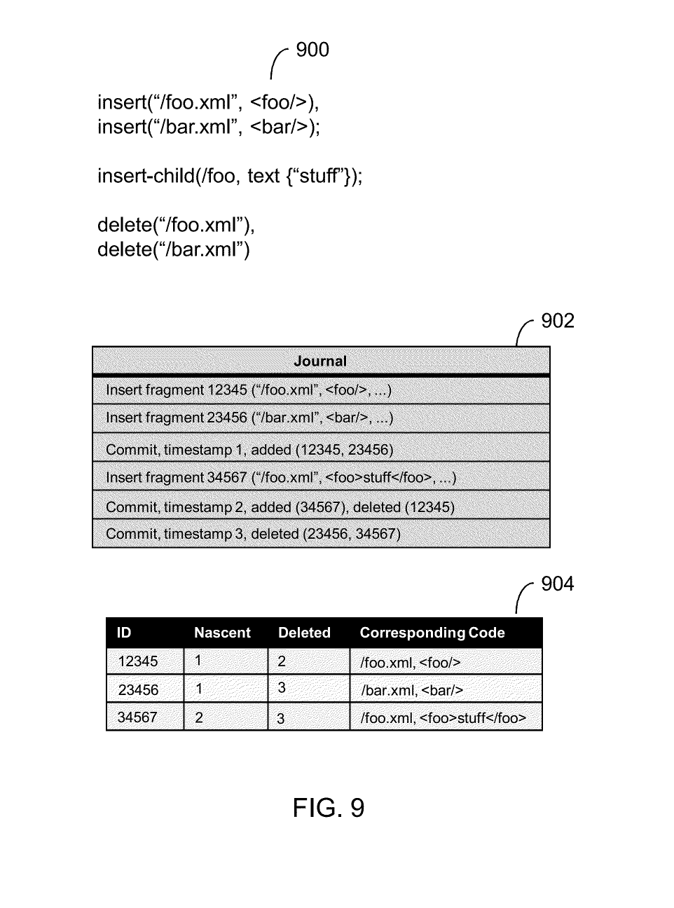

FIG. 8 illustrates processing operations that may be associated with a rebalance module associated with a partition. The rebalance module continuously checks to determine whether the assignment policy is satisfied 800. For example, the rebalance module may be in communication with the assignment policy module 722 to determine whether any documents need to be moved. If not, then control continues to loop through block 800. If the assignment policy is not satisfied (e.g., documents exist on a node that should reside on another node), then a transaction request is initiated 802. In one embodiment, the transaction request is in the form of a two-phase commit protocol, as discussed below. The transaction request is a first phase of the two-phase protocol. The second phase is a commit phase, which is tested in block 804. If a commit on a transaction is not received in a specified period of time (804—No), then the transaction is rolled back to an original state (e.g., the document remains on the node it is at). If a commit on a transaction is received (804—Yes), the transaction is completed with the document residing at the new node and the document being removed from the originating node. These changes are reflected through a journal update 806.

In this context, a transaction is an atomic set of operations on document segments in a document-oriented distributed database. A journal frame is an operation within a transaction. A journal is a log of journal frames, examples of which are provided below. The journal resides in non-transitory memory.

Thus, a rebalance module on each partition (a logical storage unit in a distributed database) operates in the background. The rebalance module keeps pushing out documents that do not “belong to” a partition. Such documents are pushed to a partition where they are supposed to be. When pushing out documents, they are deleted from the source partition and are inserted into the destination partition. The insertions and the deletions are performed in a distributed transaction to keep data consistency.

Suppose 10 documents foo1, foo2 . . . and foo10 need to be moved from parition_{—}1 742 to partition_{—}3 762 to keep the database in a balanced state. The 10 delete operations (from partition_{—}1) and 10 insert operations (into partition_{—}3) are performed in a distributed transaction. Before the transaction is successfully committed, from a user's point of view (i.e., if they try to search those documents), those 10 documents are on partition_{—}1. After the transaction is successfully committed, from a user's point of view, those 10 documents are on partition_{—}3. Importantly, if there is an unexpected error during rebalancing, a user will still see a consistent view of the data. For example, if partition_{—}3 is too busy to commit the transaction, after a certain amount of retries, the transaction will fail, which means the user will see the 10 documents still on partition_{—}1. Or if partition_{—}3 crashes and then comes back, the transaction will be replayed and if it is successfully committed this time, the user will see the 10 documents now on partition_{—}3 (and no longer on partition_{—}1).

An administrator can temporarily change the topology at any time by marking one or more partitions as Read-Only or Delete-Only. The rebalance modules act on those changes immediately. An administrator can also mark a partition as “retired” before decommissioning it. The rebalance modules automatically distribute all data on the “retired” partitions to other partitions.

Thus, the invention provides a technique for rebalancing a distributed documented-oriented database through transactions. The rebalancing process runs in a distributed way: there is one rebalance module running on each partition. This thread keeps “searching” for documents that don't “belong to” a partition based on an assignment policy. An assignment policy encapsulates the knowledge about what is considered balanced for a database. A variety of assignment policies may be used. One assignment policy is a legacy policy that uses the Uniform Resource Identifier (URI) of a document to decide which partition the document should be assigned to.

Suppose a new partition is added into a database that already has N partitions. To again get to a balanced state, the policy may require the movement of (1+2+ . . . +N)×(1/N−1/(N+1))=½ of the data.

A bucket policy also uses the URI of a document to decide which partition the document should be assigned to. But the URI is first “mapped” to a bucket then the bucket is “mapped” to a partition. Suppose there are M buckets and M is sufficiently large. Also suppose a new partition is added into a database that already has N partitions. To again get to a balanced state, the bucket policy may specify the movement of N×(M/N−M/(N+1))×1/M=1/(N+1) of the data. This is almost ideal. However, the larger the value of M is, the more costly the management of the mapping (from bucket to partition) is.

The mapping from a bucket to a partition may be kept in memory for fast access. To help explain how it is defined, here is a very small mapping (or “routing table”) with the number of buckets=10:

| # OF | BUCKET | BUCKET | BUCKET | BUCKET | BUCKET | BUCKET | BUCKET | BUCKET | BUCKET | BUCKET |
|---|---|---|---|---|---|---|---|---|---|---|
| PARTITIONS | # 1 | # 2 | # 3 | # 4 | # 5 | # 6 | # 7 | # 8 | # 9 | # 10 |
| 1 | 1 | 1 | 1 | 1 | 1 | 1 | 1 | 1 | 1 | 1 |
| 2 | 1 | 1 | 1 | 1 | 1 | 2 | 2 | 2 | 2 | 2 |
| 3 | 1 | 1 | 1 | 1 | 3 | 2 | 2 | 2 | 3 | 3 |
| 4 | 1 | 1 | 1 | 4 | 3 | 2 | 2 | 2 | 3 | 4 |
| 5 | 1 | 1 | 5 | 4 | 3 | 2 | 2 | 5 | 3 | 4 |

For a node with no more than ˜1K partitions, a good choice for the number of buckets is 16K. The total amount of memory needed to store a “routing table” of the type shown above will not exceed 1K×16K×2 bytes=32 MB. Since this is a per-server memory requirement, it is very manageable.

A statistical policy does not map a URI to a partition based on deterministic math calculations. Instead, it assigns a document to the partition that has the least number of documents among all partitions in the database. When a new partition is added, to again get to a balanced state, the statistical policy moves the least number of documents. Note that all partitions do not have to have the exact same amount of documents for a database to be considered “balanced”. For example, when the document counts of two forests have less than +/−5% difference, no data movement is necessary. To implement the statistical policy, each partition keeps track of how many documents it has and broadcasts that information through heartbeats.

A range policy is designed for the use case of Tiered Storage. Tiered Storage may have older data on slower storage systems while more recent data is on faster storage systems. It uses a range index value to decide which partition a document should be assigned to. That is, a range index can be used for date/time value partitions of data. An administrator specifies a range index as the “partition key” of a database and each forest in the database is configured with a lower bound and an upper bound.

There may be multiple partitions that cover the exact same range but it is a misconfiguration for two partitions to have partially overlapped ranges. For example, it is acceptable for both a first partition and a second partition to cover (1 to 10) but it is not acceptable for a first partition to cover (1 to 6) while a second partition covers (4 to 10). Also, it is not acceptable for a first partition to cover (1 to 10) while a second partition covers (4 to 9).

When a rebalance module finds any documents that don't belong to a partition, it initiates a distributed transaction that contains operations to remove those documents from the partition as well as operations to insert those documents in the appropriate partition. Which partition is the “right place” for a certain document is defined by the assignment policy. If there are unexpected errors (for example, the destination node crashes) while running the transaction, it is rolled back so those documents will still be on the originating partition. Because both the deletions and the insertions are in the same transaction, an application at a higher level won't see two copies of a document while the transaction is running

The invention may be implemented using a two-phase commit protocol. A two-phase commit protocol is a distributed algorithm that coordinates all the processes that participate in a distributed atomic transaction. Coordination is based upon whether to commit or roll back (abort) the transaction. Thus, it is a type of consensus protocol. The protocol achieves its goal even in cases of temporary system failure (involving either process, network node, communication, or other failures).

To recover from failure the protocol's participants use logging of the protocol's states. Log records, which are typically slow to generate but survive failures, are used by the protocol's recovery procedures. Many protocol variants exist that primarily differ in logging strategies and recovery mechanisms. When no failure occurs, a distributed transaction has two phases. A first phase is a commit-request phase (or voting phase), in which a coordinator process attempts to prepare all the transaction's participating processes (named participants, cohorts, or workers) to take the necessary steps for either committing or aborting the transaction and to vote either “Yes”: commit (if the transaction participant's local portion execution has ended properly), or “No”: abort (if a problem has been detected with the local portion). The second phase is a commit phase in which, based on voting of the cohorts, the coordinator decides whether to commit (only if all have voted “Yes”) or abort the transaction (otherwise), and notifies the result to all the cohorts. The cohorts then follow with the needed actions (commit or abort) with their local transactional resources (also called recoverable resources; e.g., database data) and their respective portions in the transaction's other output (if applicable).

An embodiment of the invention utilizes a journal, which is a series of frames that collectively describe transactions, such as insert, commit, abort, prepare, distributed begin, distributed end, etc. Typically, successive frame sequence numbers are used. Frames for different transactions can be interleaved. The invention may also be implemented with a journal proxy, referred to as a checkpoint, which has selected information from the journal. For example, the checkpoint may update a partition table to point to a current frame in a journal.

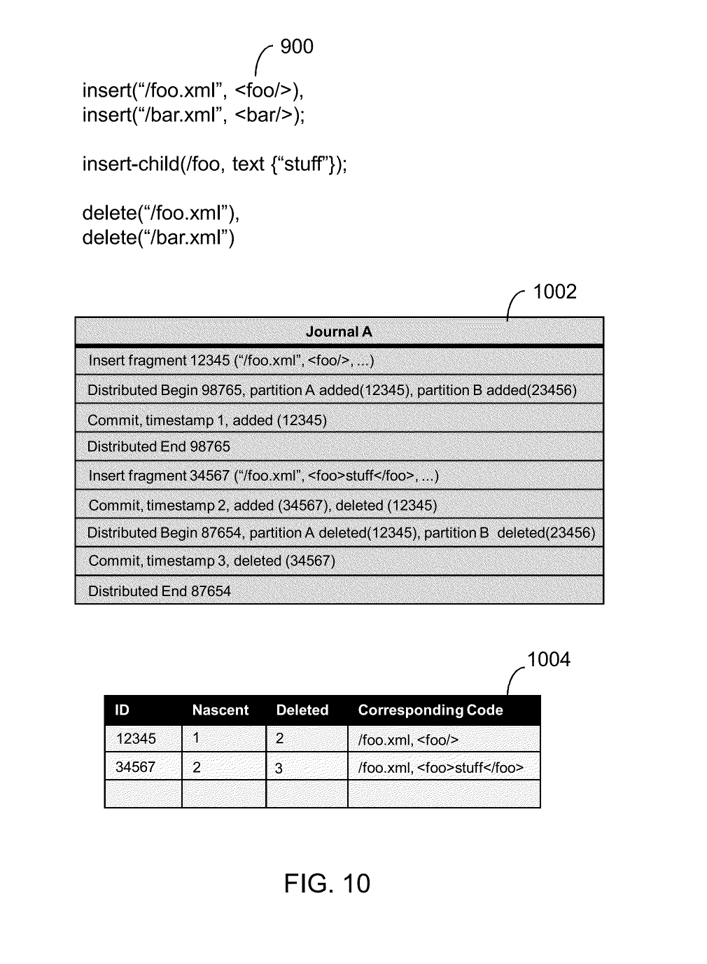

FIG. 9 illustrates a set of rebalance instructions 900, associated entries in a journal 902 and associated entries in a check point 904 for a single partition. The code in FIG. 9 specifies the insertion of two documents, the insertion of a child node dependent upon an inserted document and then the deletion of the two documents. While a rebalance transaction would not typically have an operation such as child insertion, the code nevertheless demonstrates transaction operations of the type that may be used in accordance with embodiments of the invention.

The first entry in journal 902 indicates the insertion of the document associated with the first line of rebalance instructions 900. The insertion as an associated fragment number (i.e., 12345). The second entry in journal 902 indicates the insertion of the document associated with the second line of rebalance instructions 900. This insertion has an associated fragment number (i.e., 23456). The third entry in the journal is a commit with an associated time stamp (i.e., timestamp 1). The commit transaction indicates that fragments 12345 and 23456 are added. Next, the dependent child node of the third line of rebalance instructions 900 is entered into the journal with an associated fragment number of 34567. The next line of journal 902 indicates that a commit operation occurs at timestamp 2. In this commit operation, fragment 34567 is added, while fragment 12345 is deleted, corresponding to the second to last line of rebalance instructions 900. The last line of journal 902 is a commit operation at timestamp 3, which deletes fragment 23456, corresponding to the delete operation of the last line of code in rebalance instructions 900. The fragment 34567 is deleted based upon dependency.

Check point 904 has a column to specify the different fragments processed by the journal 902. A nascent column may be used to specify an uncompleted time stamp. A deleted column may be used to specify a deleted fragment; the number in the deleted column corresponds to the timestamp number at the time of deletion. A corresponding code column may be used as a link to the rebalance instructions 900.

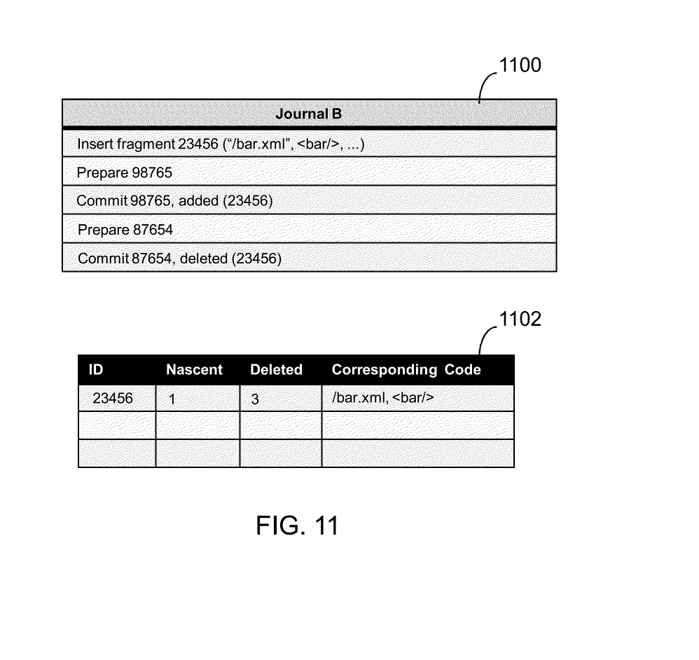

FIG. 10 illustrates the same rebalance instructions 900 being processed in a multiple partition environment. The first entry in journal 1002 is the same as the first entry in journal 902. The second entry in journal 1002 specifies a distributed transaction 98765 with an entry (12345) in partition A and another entry (23456) in partition B. The third line of journal 1002 indicates a commit at timestamp 1 for the addition (12345) in partition A. The fourth line of journal 1002 specifies the end of distributed transaction 98765. The fifth line of journal 1002 specifies an insert of fragment 34567. The sixth line specifies a commit at timestamp 2, at which point fragment 34567 is added and fragment 12345 is deleted. The seventh line specifies another distributed transaction 87654 with a deletion of 12345 from partition A and a deletion of 23456 from partition B. The eighth line specifies a commit at timestamp 3 for the deletion of 34567. The last line indicates the end of distributed transaction 87654. Checkpoint 1004 has entries relevant to journal A, namely transactions 12345 and 34567.

FIG. 11 illustrates a journal 1100 for journal B corresponding to partition B. The first line specifies the insertion of fragment 23456. The second line specifies the preparation of transaction 98765. The third line specifies the commit of transaction 98765, at which point fragment 23456 is added. The fourth line specifies the preparation of transaction 87654, while the final line specifies the commit of transaction 87654, resulting in the deletion of fragment 23456. The checkpoint 1102 specifies the processing of fragment 23456.

An administrator can mark a partition as Read-Only or Delete-Only at any time. This temporarily changes the topology and the rebalance modules will immediately adjust to this change, again based on the rules defined by the “assignment policy”. If a partition is to be decommissioned, the administrator can first mark the partition as “retired”, which is another change the rebalance modules will detect and act upon. The rebalance modules will automatically move all data in the retired partition to other partitions. An administrator can also turn off the whole rebalancing process at any time and can even turn off a rebalance module on a certain partition.

Those skilled in the art will recognize a number of advantages associated with the disclosed technology. First, rebalancing may be obtained without a deep knowledge of the underlying application. Second, rebalancing is possible without downtime since the rebalancing transactions are interspersed with normal user transactions. There is a read lock and a write lock for each document. Both the rebalancing transactions and normal user transactions must obtain the same set of locks if they need to access the same set of documents. They are essentially serialized on those locks so that it is safe to perform normal user transactions even when the rebalancers are running This guarantees that from a user's point of view, the system has no downtime while doing rebalancing. Another advantage associated with the invention is that one can easily add or delete partitions and/or worker nodes to a database and the system automatically rebalances documents across all partitions of the database.

In one embodiment, rebalancing operations are operable through an Application Program Interface (API). For example, access to the assignment policy module 722 may be through an API. In one embodiment, user interfaces support automation and command line interfaces. In one embodiment, rebalancing is throttled to manage the impact on the system.

An embodiment of the present invention relates to a computer storage product with a computer readable storage medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs, DVDs and holographic devices; magneto-optical media; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using JAVA®, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A method, comprising;
storing a partition of a distributed document-oriented database in a computer;
determining whether an assignment policy is unsatisfied, wherein the assignment policy specifies locations for documents within the distributed document-oriented database;
requesting a transfer transaction to move a document from the computer when the assignment policy is unsatisfied;
waiting for an indication of a transfer transaction commit or a transfer transaction abort;
completing the transfer transaction in the event of a transfer transaction commit, such that the document is moved from the computer; and
aborting the transfer transaction in the event of a transfer transaction abort, such that the document remains at the computer.

2. The method of claim 1 further comprising accessing the assignment policy on another computer associated with the distributed document-oriented database.

3. The method of claim 2 wherein the assignment policy is selected from a legacy policy that uses a Uniform Resource Identifier of a document to decide which partition the document should be assigned to, a bucket policy that uses a Uniform Resource Identifier to map to a bucket that is mapped to a partition, a statistical policy that maps a document to a partition that has the least number of documents and a range policy that uses a range index value to map to a partition.

4. The method of claim 1 wherein the transfer transaction state is recorded in a journal specifying transaction fragment inserts, transfer transaction commits, transfer transaction aborts, transfer transaction deletes, transfer transaction distributed begins and transfer transaction distributed ends.

5. The method of claim 4 further comprising a proxy for the journal to record a subset of information within the journal.

6. A non-transitory computer readable storage medium comprising instructions executed by a processor to:
store a partition of a distributed document-oriented database in a computer;
request a transfer transaction to move a document from the computer;
log the state of the transfer transaction on the computer until the transfer transaction is committed; and
remove the document from the computer after the transfer transaction is committed, such that the document resides on another resource associated with the distributed document-oriented database.

7. The non-transitory computer readable storage medium of claim 6 wherein the log specifies transaction fragment inserts, transfer transaction commits, transfer transaction aborts, transfer transaction deletes, transfer transaction distributed begins and transfer transaction distributed ends.

8. The non-transitory computer readable storage medium of claim 7 further comprising instructions executed by the processor to define a proxy for the log to record a subset of information within the log.

9. The non-transitory computer readable storage medium of claim 6 further comprising instructions executed by the processor to determine whether an assignment policy is satisfied, wherein the assignment policy specifies locations for documents within the distributed document-oriented database and wherein the request for the transfer transaction is initiated when the assignment policy is unsatisfied.

10. The non-transitory computer readable storage medium of claim 9 further comprising instructions executed by the processor to access the assignment policy on another resource associated with the distributed document-oriented database.

11. The non-transitory computer readable storage medium of claim 9 wherein the assignment policy is selected from a legacy policy that uses a Uniform Resource Identifier of a document to decide which partition the document should be assigned to, a bucket policy that uses a Uniform Resource Identifier to map to a bucket that is mapped to a partition, a statistical policy that maps a document to a partition that has the least number of documents and a range policy that uses a range index value to map to a partition.
